(19) United States
(12) Patent Application Publication
(10) Pub. No.: US 2004/0046998 A1
(43) Pub. Date: Mar. 11, 2004

(54) Image forming apparatus and program executing method in image forming apparatus

(75) Inventor: Yuki Ito, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/238,734

(22) Filed: Sep. 11, 2002

(51) Int. Cl. G06F 15/00; B41F 1/00

(52) U.S. Cl. 358/1.16; 358/1.15

(57) ABSTRACT

The present invention as disclosed hereby is to provide an image forming apparatus in which a program compressed and stored in a nonvolatile storage medium can be expanded in hardware in a short time by a codec circuit. The image forming apparatus comprises: an FROM adapt for storing therein a program in a compressed state; a codec circuit adapted for expanding a compressed program; and a CPU adapted for reading the compressed program out of the FROM if needs be, allowing the codec circuit to expand the compressed program and develop it into a RAM for a program execution. Specifically, if the CPU reads a compressed program out of the FROM at the time of booting-up and applies it to the codec circuit, the codec circuit can expand the compressed program in hardware in a short time to develop it into the RAM, thereby advantageously shortening a period of time for the expansion processing while maintaining the benefit obtained from saving in capacity of the nonvolatile storage medium.

### BACKGROUND OF THE INVENTION

1. Field of the Invention

The present invention relates to an image forming apparatus such as a digital copying machine, and particularly relates to an image forming apparatus having a multifunction of a printing function, a scanning function, a facsimile function and the like in addition to a copying function. More particularly the present invention relates to an image forming apparatus capable of retaining reduced programs for all of or some of such functions and a program executing method for executing such programs.

2. Description of the Related Art

These image forming apparatus have recently been advanced in its multifunction and developed in the form of a digital copying machine. For instance, such a digital copying machine as an example of the image forming apparatus is configured to have a multifunction such as a printer function, a scanner function, a facsimile function and the like. As the multifunction is advanced, programs included in a software and used for the multifunction are more remarkably increased in capacity. The software used for the digital copying machine with the multifunction is stored in a nonvolatile storage medium such as a ROM and the like. However, the storage medium must be increased in capacity because of such a remarkable increase of the program capacity thereby disadvantageously increasing cost. In order to dissolve this problem, upon storing the software in the nonvolatile storage medium, the programs are compressed and stored in the nonvolatile storage medium and, at the time of booting-up, the programs which have been compressed and stored therein are allowed to be expanded and executed by a booting program.

In the conventional image forming apparatus as described above, programs to be executed for respective functions such as a copying function, a printer function, a scanner function, a facsimile function and like are compressed and stored in a nonvolatile storage medium and then, in use, these programs are expanded in software to be executed. At the time of booting-up, it disadvantageously takes a lot of time to expand and develop the programs by the booting program. Accordingly, there is a benefit obtained from saving in capacity of the nonvolatile storage medium by using a program compression processing, but there is occurred a problem of a lot of time required for the expansion processing by using the booting program.

### SUMMARY OF THE INVENTION

The present invention is accomplished for eliminating this problem and other problems and therefore an object of the present invention is to provide an image forming apparatus and a program executing method by which a program compressed and stored in a nonvolatile storage medium, at the time of booting-up, is expanded in hardware by a codec circuit or particularly a existing codec circuit prepared for an image compression/expansion processing, independently of a booting program so that a period of time expended for an expansion processing can be shortened while maintaining the benefit obtained from saving in capacity of the nonvolatile storage medium.

In order to dissolve this problem and other problems, the image forming apparatus according to the present invention comprises:

a nonvolatile storage medium adapted to store therein a program in a compressed state;

a random readable and writable storage medium;

a codec circuit adapted to expand a compressed program; and

a control section adapted to read the compressed program out of the nonvolatile storage medium if needs be, allow the codec circuit to expand the compressed program and develop it into the random readable and writable storage medium for execution of the developed program.

In general, a control section of the image forming apparatus requires a program stored in the nonvolatile storage medium at the time of its booting-up. However, with this configuration as above, if the program is stored in a compression state, the compressed program is read into the codec circuit by which the compressed program can be expanded in hardware in a short time and developed into a random readable and writable storage medium, as a result of which a period of time for the expansion processing is effectively shortened while maintaining the benefit obtained from saving in capacity of the nonvolatile storage medium.

Also, the codec circuit according to the present invention can perform an image data compression/expansion for an image processing and particular expand a compressed program depending on a compressed program expansion setting thereof Therefore, at the time of booting-up, the control section sets the codec circuit to be initialized so that the codec circuit can expand the compressed program.

With this configuration, the codec circuit according to the present invention can be substituted with an existing codec circuit for the image data compression/expansion. For that implementation, the control section may be configured to activate the compressed program expansion setting of the codec circuit. Thus, any newly additional hardware components are not required other than conventional ones but a certain correction is only required in its control program.

Moreover, the control section executes various processing operations according to a booting program incorporating therein both of a processing operation for deciding whether a program read out of the nonvolatile storage medium is compressed or not and a processing operation for allowing the codec circuit to expand the compressed program and develop it into the random readable and writable storage medium.

With this configuration, any inconvenience is not occurred even if the nonvolatile storage medium stores therein the compressed programs and the non-compressed programs mixedly. Only when a development of the compressed program is required, the control section can allow the codec circuit to selectively expand that compressed program.

Also, according to another aspect of the present invention, there is provided a program executing method in an image forming apparatus comprising: a nonvolatile storage medium adapted to store therein a program in a compressed state; a random readable and writable storage medium; and a codec circuit adapted to expand a compressed program. The program executing method comprises the steps of:

reading a compressed program out of the nonvolatile storage medium if needs be;

allowing the codec circuit to expand the read compressed program; and

developing the expanded program into the random readable and writable storage medium for execution of the program.

According to a yet other aspect of the present invention, there is provided a program executing method in an image forming apparatus comprising: a nonvolatile storage medium adapted to store therein a program in a compressed state; a random readable and writable storage medium; and a codec circuit adapted to expand a compressed program. The program executing method comprises the steps of:

reading a compressed program out of the nonvolatile storage medium if needs be;

deciding whether the program read out of the nonvolatile storage medium is a compressed program or not;

in the event that the program read out of the nonvolatile storage medium has been decided to be a compressed program, allowing the codec circuit to expand the compressed program; and

developing the expanded program into the random readable and writable storage medium for execution of the program.

### BRIEF DESCRIPTION OF THE DRAWINGS

FIG. 1 is a schematic block diagram showing an image forming apparatus as a preferred embodiment according to the present invention;

FIG. 2 illustrates a memory map for explaining a content of programs stored in an FROM of the image forming apparatus of FIG. 1;

FIG. 3 is a schematic block diagram for explaining execution processes for programs stored in the FROM of the image forming apparatus of FIG. 1;

FIG. 4 is a flow chart, in cooperation with FIG. 3, for explaining the execution processes of the programs stored in the FROM of the image forming apparatus of FIG. 1; and

FIG. 5 is a flow chart for explaining execution processes of programs stored in an FROM as another embodiment according to the present invention.

### PREFERRED EMBODIMENT OF THE PRESENT INVENTION

Hereinafter, a preferred embodiment according to the present invention will be described in detail with reference to the accompanying drawings.

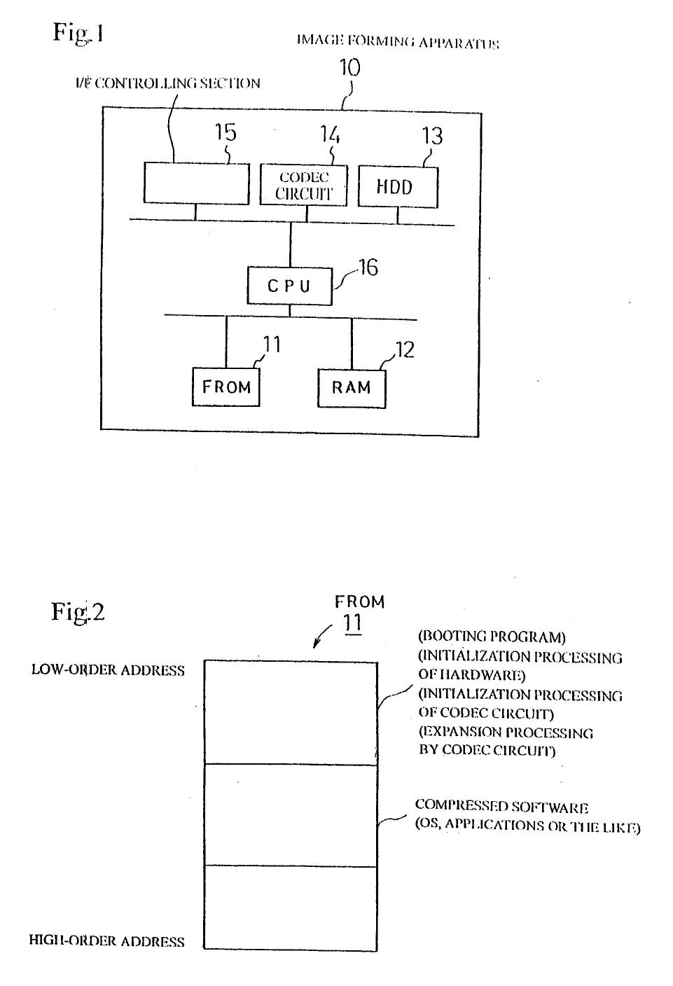

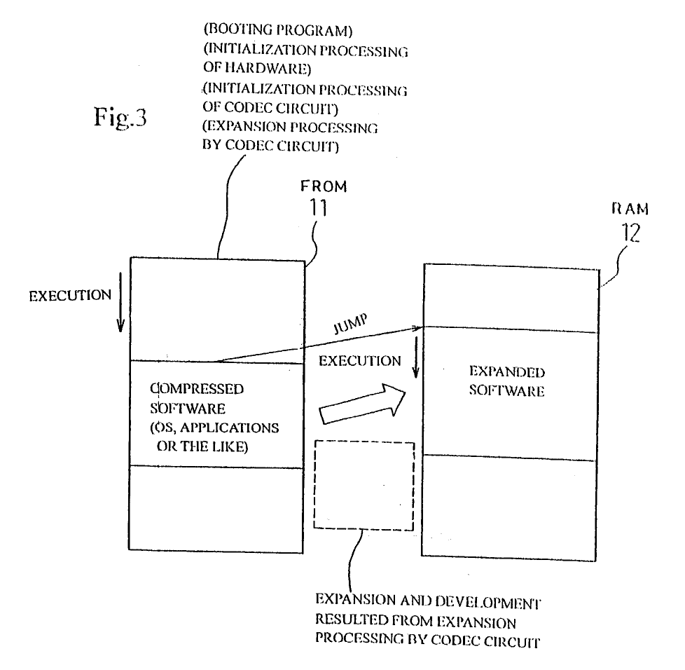

Referred to FIG. 1, an image forming apparatus 10 as the preferred embodiment according to the present invention which is a so-called digital copying machine, comprises: an FROM (Flash Read Only Memory) 11, a RAM (Random Access Memory) 12, a HDD (Hard Disk Drive) 13, a codec circuit 14, an I/F (Interface) controlling section 15, and a CPU (Central Processing Unit) 16. The FROM 11 which is a nonvolatile storage medium stores therein a non-compressed booting program and compressed processing programs of software required for processing various processing operations. More specifically, in the FROM 11 as illustrated in a memory map of FIG. 2, the non-compressed booting program is stored at a low-order address while at higher-order addresses OS's (operating Systems) and processing programs required for processing various application programs are stored. In this configuration, at the time of booting-up, the booting program at the low-order address of the FROM 11 is initially booted up.

Specifically, the non-compressed booting program as described above does not include a conventional extensive booting program, but includes programs required for a minimal initialization processing of the hardware of the image forming apparatus to boot the OS, an initialization processing of the codec circuit 14, and a simple expansion processing for expanding data on the FROM 11 by the initialized codec circuit 14 to develop the data into a RAM 12 as a random readable and writable storage medium. The RAM 12 is a volatile memory having a region for developing and executing a compressed processing program and a region for temporarily storing image data and various information. The HDD 13 is a nonvolatile storage medium capable of storing image data and various information.

The codec circuit 14 is configured to be able to compress and expand data (e.g., image data) dealt with by this digital copying machine. In this case, the resultant compressed or expanded data can be transferred to the RAM 12 or the HDD 13. The interface controlling section 15 is adapted to control a communication to a scanner section or a printer engine of this digital copying machine itself and control an interface control through a LAN (Local Area Network) or a telephone line for execution of a printer function, a scanner function, a facsimile function or the like. The CPU 16 is adapted to, in addition to execution of a program stored in the FROM 11 or a program developed in the RAM 12, control the forementioned various sections such as the codec circuit 14, the interface controlling sections 15 or the like to perform a transfer, operation and processing of image data and various information.

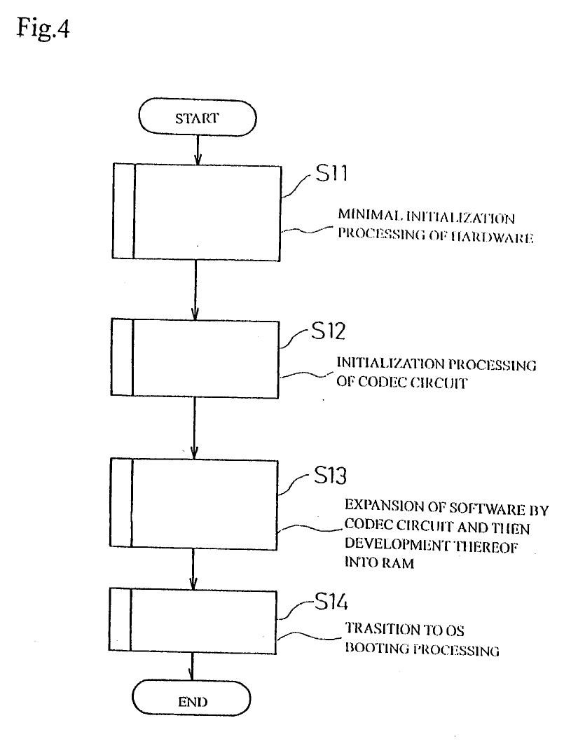

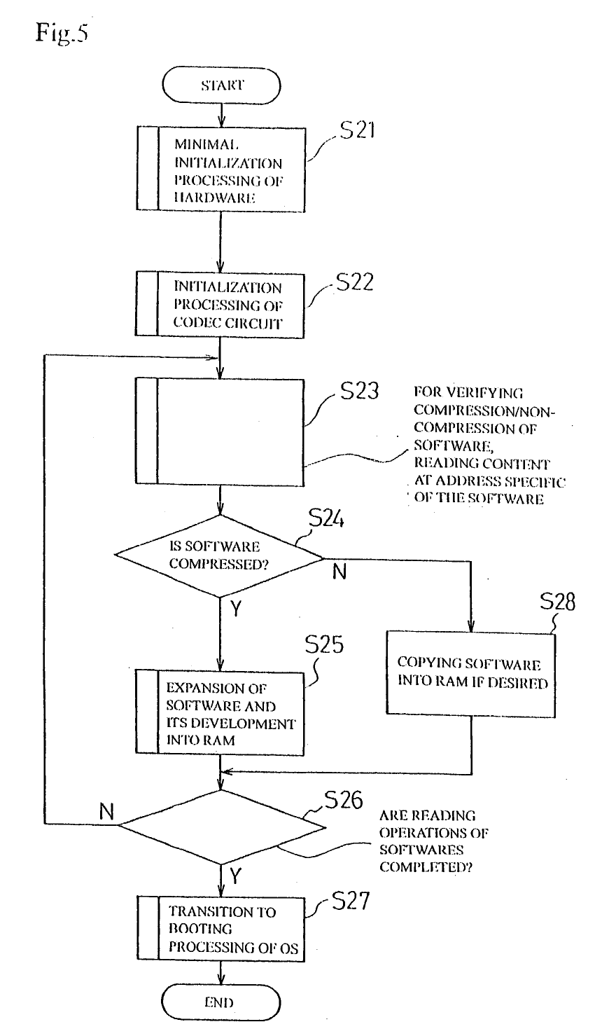

Next, control operations of various programs by the forementioned image forming apparatus 10 at the time of booting-up will be described with reference to FIGS. 3 and 4. At the time of booting-up, the CPU 16 reads and executes a booting program stored at a low-order address within the FROM 11 (as shown in FIG. 3). With execution of this booting program, the CPU 16 executes minimal initialization processing operations of various hardware components in the image forming apparatus 10 (step 11) and subsequently executes an initialization processing operation of the codec circuit 14 (step 12). Thereafter, the CPU 16 passes software (the OS or applications) stored in the FROM 11 to the codec circuit 14 to develop programs expanded by the codec circuit 14 into the RAM 12 (step 13).

After completion of the software development into the RAM 12 by the codec circuit 14 followed by the execution of a final step of the booting program, the CPU 16 transit its execution operation from the booting program to the programs developed into the RAM 12 to, first of all, begin with the booting processing of the OS (step 14). Upon booting-up of the OS, since the initialization processing and the like of the codec circuit 14 have already been completed, a further initialization processing of the codec circuit 14 must not be executed for processing of the image data and the like. In this way, primary portions of the expansion processings of the OS, the applications and the like are performed by using the existing codec circuit 14, but not required to be performed by the booting program, so that such primary portions can be performed in hardware so as to shorten running time, thereby saving an increase of cost. Accordingly, the expansion processing can be performed in a short time while maintaining the benefit of an ability to reduce a storage capacity due to data compression.

Next, an image forming apparatus as another embodiment according to the present invention will be described with reference to FIG. 5. This image forming apparatus is similar in configuration to that of the image forming apparatus as shown in FIG. 1, but its FROM 11 stores a compressed software and a non-compressed software in the form of their mixture. Its CPU 16 separates the softwares after passing through various steps as described below, to perform any expansion processing if needs be to execute various processing operations. Steps 21 and 22 are similar to those described in FIG. 1 through FIG. 4. After step 22, the CPU 16 sequentially reads more necessary one of softwares stored in the FROM 11. In this case, the CPU 16 reads a content at an address specific of the software (step 23) and decides whether the software is in a compressed state or non-compressed state (step 24).

In the event that, as a result of the decision in step 24, the software has been decided to be in a compressed state, the software will be expanded and developed in RAM 12 by the codec circuit 14 (step 25). After development, it is decided whether necessary reading operations of the softwares are completed or not (step 26). In the event that the necessary reading operations have been decided not to be completed, this flow transits to step 23. However, it the event that the necessary reading operations have been decided to be completed, the flow transits to the booting processing of the OS developed in the RAM 12 (step 27). In step 24, if the software has been decided not to be in a compressed state, the software is enabled to be executed on the FROM 11 as it is or copied into the RAM 12 for its execution (step 28), thereafter transiting this flow to step 26. In this way even if the compressed softwares and the non-compressed softwares are mixedly stored in the FROM 11, the CPU 16 can process those softwares to be appropriately executable. In that case, the expansion of the compressed softwares is performed by the codec circuit 14 as a hardware so that its processing operation can be completed in a short time.

The image forming apparatus as the embodiment according to the present invention is configured as described above. In general, a control section of the image forming apparatus requires a program stored in the nonvolatile storage medium at the time of its booting-up. However, if the program is stored in a compression state, the compressed program is read into the codec circuit by which the compressed program can be expanded in hardware in a short time and developed into a random readable and writable storage medium according to the present invention, as a result of which a period of time for the expansion processing is effectively shortened while maintaining the benefit obtained from saving in capacity of the nonvolatile storage medium.

Also, the codec circuit as described above can be substituted with an existing codec circuit for an image data compression/expansion. For that implementation, the control section may be configured to activate a compressed program expansion setting of the codec circuit. Thus, any newly additional hardware components are not required other than conventional ones but a certain correction is only required in its control program. Furthermore, both of a processing operation for deciding whether a program read out of the nonvolatile storage medium is compressed or not and a processing operation for allowing the codec circuit to expand the compressed program and develop it into the random readable and writable storage medium are incorporated into the booting program according to the present invention. As a result, even if the compressed programs and the non-compressed programs are mixedly stored, any inconvenience is not occurred. In particular, only when a development of the compressed program is required, it is advantageously possible to allow the codec circuit to selectively expand that compressed program.

What is claimed is:

1. An image forming apparatus comprising:
a nonvolatile storage medium adapted to store therein a program in a compressed state;
a random readable and writable storage medium;
a codec circuit adapted to expand a compressed program; and
a control section adapted to read the compressed program out of said nonvolatile storage medium if needs be, allow said codec circuit to expand the compressed program and develop it into said random readable and writable storage medium for execution of said developed program.

2. An image forming apparatus as claimed in claim 1, wherein said codec circuit is capable of compressing and expanding image data for image processing and further capable of expanding the compressed program upon an expanding setting thereof, and wherein said control section, at the time of booting-up, activates an initialization setting of said codec circuit so that said codec circuit can expand the compressed program.

3. An image forming apparatus as claimed in claim 1, wherein said control section executes various processing operations according to a booting program incorporating therein both of a processing operation for deciding whether a program read out of the nonvolatile storage medium is compressed or not and a processing operation for allowing said codec circuit to expand the compressed program and develop it into said random readable and writable storage medium.

4. In an image forming apparatus comprising: a nonvolatile storage medium adapted to store therein a program in a compressed state; a random readable and writable storage medium; and a codec circuit adapted to expand a compressed program, a program executing method comprising the steps of:
reading a compressed program out of said nonvolatile storage medium if needs be;
allowing said codec circuit to expand said read compressed program; and
developing said expanded program into said random readable and writable storage medium for execution of said program.

5. In an image forming apparatus comprising: a nonvolatile storage medium adapted to store therein a program in a compressed state; a random readable and writable storage medium; and a codec circuit adapted to expand a compressed program, a program executing method comprising the steps of:
reading a compressed program out of said nonvolatile storage medium if needs be;
deciding whether said program read out of said nonvolatile storage medium is a compressed program or not;
in the event that said program read out of said nonvolatile storage medium has been decided to be a compressed program, allowing said codec circuit to expand said compressed program; and
developing said expanded program into said random readable and writable storage medium for execution of said program.
